(19) United States
(12) Patent Application Publication
(10) Pub. No.: US 2026/0037359 A1
(43) Pub. Date: Feb. 5, 2026

(54) Methods for Error Cause Determination for Two-Sided Models Independently Trained by Different Vendors

(71) Applicant: InterDigital Patent Holdings, Inc., Wilmington, DE (US)

(72) Inventors: Mihaela Beluri, Jericho, NY (US); Patrick Tooher, Montreal (CA); Moon IL Lee, Melville, NY (US); Keya Patani, London (GB); Yugeswar Deenoo Narayanan Thangaraj, Chalfont, PA (US)

(73) Assignee: InterDigital Patent Holdings, Inc., Wilmington, DE (US)

(21) Appl. No.: 18/794,901

(22) Filed: Aug. 5, 2024

(51) Int. Cl. G06F 11/07; G06Q 10/0639

(52) U.S. Cl. CPC G06F 11/079; G06Q 10/06393

(57) ABSTRACT

An example Wireless Transmit/Receive Unit (WTRU) comprising a processor is provided. The processor is configured to receive configuration information for a machine learning (ML) model. The processor is further configured to receive a request for activating an assessment mode associated with the ML model. The processor is further configured to collect measurements for the assessment mode. The processor is further configured to determine an error cause associated with the ML model based on the measurements. The processor is further configured to send one or more reports that include at least one of an indication of the error cause, an indication of a measurement related to the error cause, or an indication of a mitigation action for the error cause.

### BACKGROUND

In some applications, such as in the third generation partnership project (3GPP), advances in technologies such as Channel State Information (CSI) compression are being considered as a potential way to reduce CSI feedback reporting overhead.

### SUMMARY

An example Wireless Transmit/Receive Unit (WTRU) that includes a processor is disclosed. The processor is configured to receive configuration information for a machine learning (ML) model. The processor is further configured to receive a request for activating an assessment mode associated with the ML model. The processor is further configured to collect measurements for the assessment mode. The processor is further configured to determine an error cause associated with the ML model based on the measurements. The determined error cause may include an indication of at least one of: data distribution measurements being out-of-distribution (OOD) with respect to a dataset used to train the ML model, or an identity of a device at which the error cause occurred when implementing the ML model. The processor is further configured to send one or more reports that include at least one of: an indication of the error cause, an indication of a measurement related to the error cause, or an indication of a mitigation action for the error cause.

In examples, the request includes an indication of a time window, and the processor is configured to collect the measurements during the time window indicated in the request. In examples, the ML model is a two-sided ML model that includes a first-side model associated with a first node and a second-side model associated with a second node. In examples, the first node is the WTRU. In examples, the processor, to determine the error cause, is configured to associate an error with at least one of: the first-side model, the second-side model, or interoperability between the first-side model and the second-side model. In examples, the processor, to determine the error cause, is configured to determine whether data associated with the collected measurements is out-of-distribution (OOD) with respect to training data used to train the first-side model or the second-side model. In examples, the processor is configured to determine that the error cause corresponds to data drift based on a determination that the data associated with the collected measurements is OOD. In examples, the configuration information includes one or more parameters for the assessment mode. In examples, the one or more parameters include at least one of: an identifier associated with a dataset used to train a reference ML encoder, an identifier associated with parameters of the reference ML encoder, parameters for OOD detection, or one or more threshold values associated with one or more intermediate key performance indicators (KPIs). In examples, the processor, to collect the measurements, is configured to determine end-to-end (E2E) performance statistics associated with one or more of: hybrid automatic repeat request (HARQ) acknowledgement or negative acknowledgement (ACK/NACK), block error rate (BLER), rank indicator (RI), or channel quality indicator (CQI). In examples, the processor, to collect the measurements, is configured to determine one or more intermediate KPIs, wherein the one or more KPIs include at least one of square generalized cosine similarity (SGCS) or normalized mean square error (NMSE). In examples, the request includes an indication of a time window and the processor, to collect the measurements, is configured to determine whether data distribution measurements are out-of-distribution (OOD) with respect to a dataset used to train the ML model based on a length of the time window exceeding a threshold. In examples, the processor is configured to send, in the one or more reports, one or more channel state information (CSI) data distribution metrics relative to a dataset used to train the ML model in response to a determination that the error cause corresponds to data drift. In examples, the processor is configured to send, in the one or more reports, one or more intermediate KPIs in response to a determination that the error cause is associated with a WTRU-side ML encoder. In examples, the processor is configured to send a report that includes an indication of one or more intermediate KPIs and one or more channel state information (CSI) data distribution metrics relative to a dataset used to train the ML model in response to a failure to determine the error cause. In examples, the mitigation action includes at least one of: a recommended mitigation action, or a determined mitigation action performed at the WTRU in response to the determination of the error cause.

An example method performed by a WTRU is disclosed. The method comprises receiving configuration information for a ML model. The method further comprises receiving a request for activating an assessment mode associated with the ML model. The method further comprises collecting measurements for the assessment mode. The method further comprises determining an error cause associated with the ML model based on the measurements. The method further comprises sending one or more reports that include at least one of: an indication of the error cause, an indication of a measurement related to the error cause, or an indication of a mitigation action for the error cause.

In examples, the request includes an indication of a time window. In examples, collecting the measurements is during the time window indicated in the request. In examples, the ML model is a two-sided ML model that includes a first-side model associated with a first node and a second-side model associated with a second node. In examples, the first node is the WTRU. In examples, determining the error cause comprises associating an error with at least one of: the first-side model, the second-side model, or interoperability between the first-side model and the second-side model. In examples, determining the error cause comprises associating an error with data drift. In examples, associating the error with data drift comprises determining that data associated with the collected measurements is out-of-distribution (OOD) with respect to training data used to train the first-side model or the second-side model.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

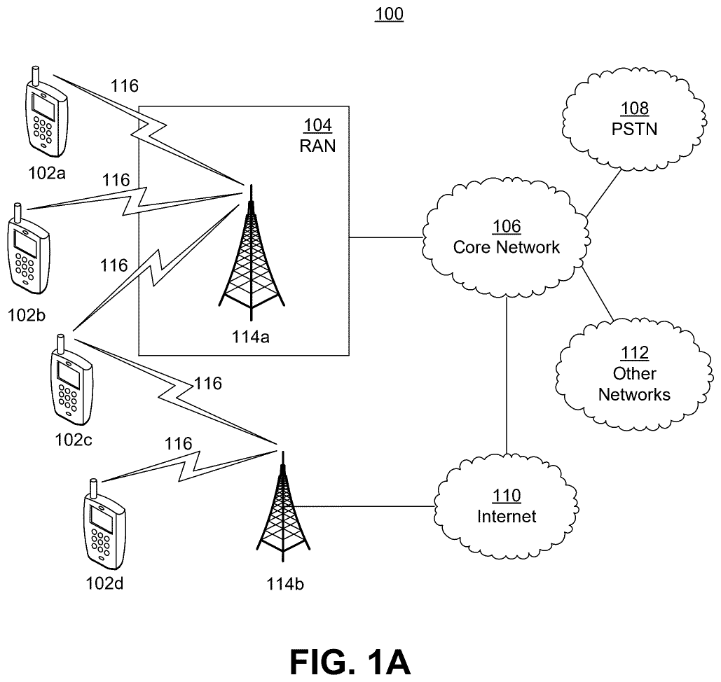

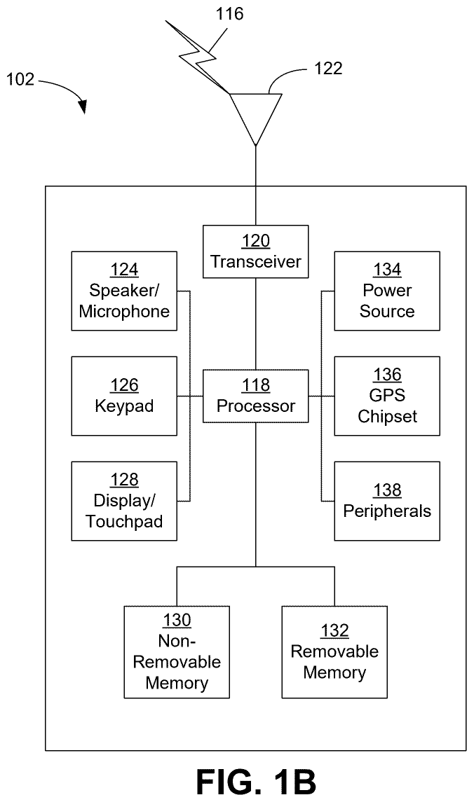

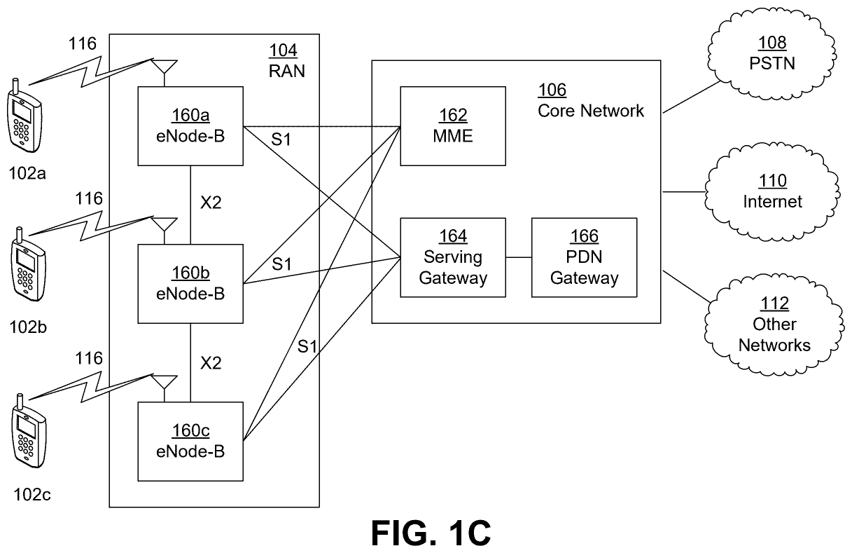

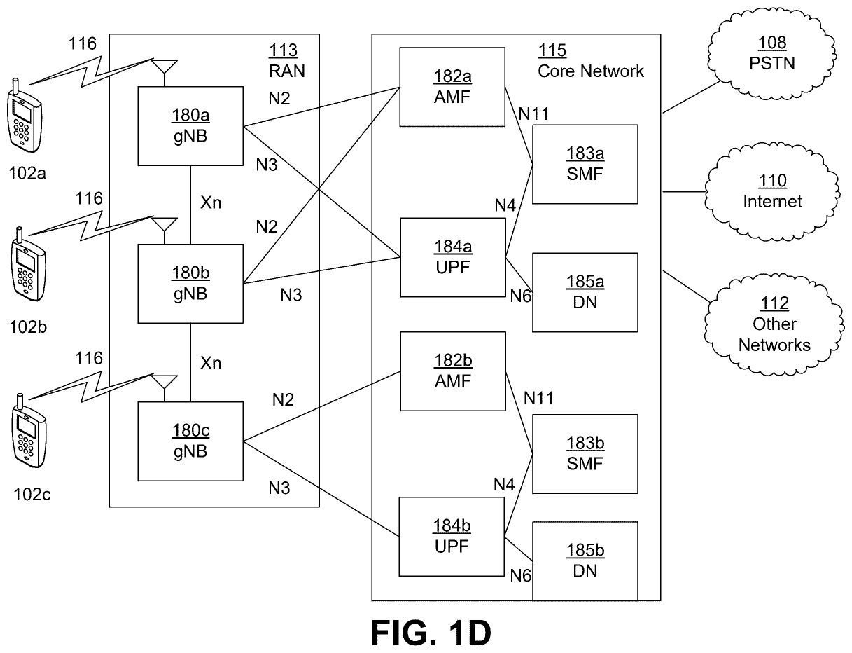

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Artificial intelligence (AI) or ML based CSI compression may potentially enable reducing CSI feedback reporting overhead. AI/ML-based CSI compression may employ a two-sided autoencoder (AE) model, in which an encoder part (e.g., WTRU-side ML encoder) may be located at a WTRU-side to perform compression and a decoder part may be located at a network side (NW-side) (e.g., NW-side ML decoder) to perform reconstruction based on received compressed CSI.

Training AI/ML models effectively may enable improved (e.g., good) system performance across different deployments, channel conditions, local conditions, and/or device/vendor specific conditions. For example, training two-sided AE models may involve training a ML encoder and a ML decoder in a loop. In some multi-vendor scenarios, where the ML encoder part (e.g., CSI generation) and the ML decoder part (e.g., CSI reconstruction) are provided by different vendors, AE training may be technically challenging. This is because training may need to balance meeting minimum performance requirements (e.g., for interoperability purposes) with exchanging information between the ML encoder (e.g., ML encoder vendor/WTRU vendor) and the ML decoder (e.g., ML decoder vendor/network (NW) vendor), while also preserving the potentially proprietary nature of various ML model implementations.

Thus, in some scenarios, training two-sided AE models for CSI compression may involve addressing interoperability considerations (e.g., to ensure system meets minimum performance requirements) while also reducing inter-vendor collaboration that may be practiced for enabling model training.

To address these issues, some example solutions involve defining standard reference models for either the ML encoder side, the ML decoder side, or both, with potentially associated training datasets. These solutions may enable off-line pre-deployment model training and provide interoperability, at least for conditions corresponding to the training datasets. However, in some scenarios, these solutions may be associated with less optimal operation in conditions different than conditions associated with the training dataset.

To improve performance and enable vendor differentiation, in some implementations, the standard reference models may further undergo vendor-side offline model engineering (e.g., to optimize/finetune the models).

In some scenarios however, it may be possible that such optimized models fail when deployed in the field. In case of a failure, it may be desirable for a NW operator to be able to determine the cause of the problem (e.g., whether it is NW-side, WTRU-side, or data drift).

Approaches to address both interoperability considerations (e.g., system meeting minimum performance requirements) and inter-vendor training collaboration complexity for two-sided models may include defining standard reference models, and/or standard reference model structure/parameters exchanged between NW vendor(s) and WTRU vendor(s). In various examples, the standard reference model/model structure may be the WTRU-side model, the NW-side model, or both the NW-side and WTRU-side models. The reference model(s) may further be optimized or enhanced separately (e.g., pre-deployment) at the vendor side (e.g., NW-side vendor, WTRU-side vendor, or both).

For example, while in the pre-deployment stage, a WTRU vendor may receive parameters and additional information from a NW vendor for a NW-trained standardized reference ML encoder structure. The additional information may include a first dataset for training and testing a reference encoder model (e.g., a reference dataset). The WTRU vendor may generate a second (e.g., enhanced) dataset using the first (e.g., reference) dataset and WTRU vendor specific data. The WTRU vendor may use the second (e.g., enhanced) dataset to perform off-line model engineering, to improve (e.g., optimize or finetune) the reference ML encoder and received parameters, and/or to generate one or more enhanced WTRU-side ML encoders. The WTRU may validate the enhanced ML encoder using the first (e.g., reference) dataset. The WTRU may be configured to deploy the enhanced (e.g., and/or validated) ML encoder in the field.

In some scenarios, vendor-side enhanced (e.g., optimized) models may fail when deployed in the field and/or end-to-end (E2E) performance may degrade. Accordingly, the present disclosure includes example implementations that involve identifying the cause of such performance degradation, for example, as being NW-side, WTRU-side, or data drift.

For example, a WTRU may be configured to perform measurements to assess an error cause (e.g., cause of the performance degradation), report (e.g., to the NW) the WTRU-assessed error cause, select (e.g., based on the WTRU-assessed error cause) one or more metrics to report, and/or report a recommended mitigation for the error cause.

The WTRU may be configured to receive configuration information associated with a ML model (e.g., configuration information for an AI/ML based operation and/or model monitoring measurements). The received configuration information may include pairing information (e.g., for a NW-side ML decoder). The WTRU may be configured to use the pairing information to select a matching ML encoder (e.g., a ML encoder that matches the NW-side ML decoder, etc.). For example, the pairing information may include a vendor identifier (ID), an ID associated with a first dataset used by the NW to train the reference ML encoder, and/or an ID associated with one or more parameters of a reference ML encoder trained by the NW vendor.

The received configuration information may additionally or alternatively include a configuration for error cause assessment measurements. For example, the configuration information may include parameters for out-of-distribution detection, such as a threshold number of samples for data distribution measurements. As another example, the configuration information may include statistical information for the first dataset (e.g., the training data used by the NW to train the reference ML encoder, etc.). As another example, the configuration information may include threshold values for intermediate KPIs (e.g., SGCS threshold, NMSE threshold).

The WTRU may be configured to receive a request for error cause assessment, e.g., when the NW determines E2E performance degradation. The request may be for activating an error cause measurement mode (e.g., an assessment mode associated with the ML model). The request may include a length of a first window for error cause measurements (e.g., a time window for the assessment mode).

The WTRU may be configured to collect measurements for the assessment mode. For example, the WTRU may be configured to perform measurements for error cause assessment during the first error cause measurement window. The measurements may include WTRU-side statistics for E2E performance (e.g., HARQ ACK/NACK statistics, BLER, RI, CQI). If the WTRU-measured E2E KPIs are below a first configured threshold, for example, the WTRU may be configured (e.g., autonomously) to fall back to non-AI/ML operation for the next reporting occasion and/or to deactivate the ML encoder model. For the remainder of the measurement window (e.g., first window or time window), in this example, the WTRU may be configured to continue to perform measurements for the error cause assessment for the deactivated ML encoder model. The measurements may include intermediate KPIs (e.g., SGCS, NMSE). In some examples, the measurements may include data distribution analysis measurements (e.g., if the measurement window length exceeds a second configured threshold). For example, the WTRU may be configured to collect (e.g., or perform) distribution measurements to determine whether current data is in- or out-of-distribution (OOD) with respect to the first dataset. In another example, the WTRU may additionally or alternatively determine whether the current data is in- or out-of-distribution (OOD) with respect to a WTRU-determined enhanced dataset (e.g., the second dataset).

The WTRU may be configured to determine (e.g., assess) the error cause based on the collected measurements (e.g., during the first error cause measurement window). Example WTRU-assessed error causes may include a WTRU-side ML encoder fault, data drift, or an undetermined cause. For example, the WTRU may determine that the error cause corresponds to data drift if current CSI data (e.g., in the collected measurements) is OOD with respect to the first (e.g., reference) dataset and/or OOD with respect to the second (e.g., enhanced) dataset. As another example, the WTRU may determine that the error cause corresponds to WTRU-side ML encoder fault when: (i) both the measured E2E and the measured intermediate performance indicators do not meet a configured target, and (ii) the current CSI data is in-distribution with respect to the first dataset. As another example, the WTRU may assess that the error cause is undetermined (e.g., failure to determine the error cause) when the measured E2E does not meet the configured target but the measured intermediate performance indicator(s) meet the configured target(s).

Accordingly, the WTRU may be configured determine the error cause by associating an error (e.g., performance degradation, encoding error, decoding error, etc.) with at least one of a first-side model (e.g., WTRU-side model), a second-side model (e.g., NW-side model), or interoperability between the first-side model and the second-side model.

The WTRU may be configured to report the WTRU-assessed error cause, WTRU-selected measurements, and/or a WTRU-determined (e.g., autonomously determined) mitigation action or a WTRU-recommended mitigation action. The WTRU-selected measurements may be selected based on the WTRU-assessed error cause. Thus, the WTRU may be configured to send one or more reports that include at least one of an indication of the error cause, an indication of a measurement associated with the error cause, or a mitigation action.

For example, when the WTRU assesses the error cause as data drift, the WTRU may be configured to report CSI data distribution metrics relative to the first (e.g., reference) dataset (e.g., OOD indicators, energy score), and/or CSI distribution metrics (e.g., Z-score, first and second order statistics of CSI data received during the first measurement window). As another example, when the WTRU assesses the error cause as undetermined, the WTRU may be configured to report the intermediate KPI (e.g., SGCS, NMSE) and CSI data distribution metrics relative to the first (e.g., reference) dataset. Alternatively or additionally, in this example, the WTRU may be configured to report the ground truth (e.g., target CSI). As another example, when the WTRU assesses the error cause as WTRI-side ML encoder fault, the WTRI may be configured to report the intermediate KPI (e.g., SGCS, NMSE). As another example, the WTRU may be configured to perform the WTRU-autonomously determined mitigation action that includes fallback to a non-AIML operation (e.g., based on WTRI-determined E2E KPIs being below a first configured threshold, and/or in response to the determination of the error cause).

In some examples, the WTRU may be configured to generate the WTRU-recommended mitigation action (e.g., based on the determined error cause), send a request for a (e.g., second) measurement window, and/or send an indication of the recommended mitigation action. In an example, the recommended mitigation may be to switch the WTRU-side ML encoder model to a candidate model. For instance, the candidate model may be the reference ML encoder or an alternative enhanced ML encoder model if available. During the second measurement window, the WTRU may be configured to perform (e.g., or collect) measurements to determine a second E2E performance (e.g., associated with the candidate model). The WTRU may receive a request for AI/ML model deactivation (e.g., and/or fallback to non-AI/ML CSI), for example, if the E2E performance reassessed during the second measurement window does not meet the target.

Thus, examples described herein may enable interoperability of systems using two-sided models by providing solutions for error cause determination (e.g., WTRU-side, NW-side, or data drift), for example, where the NW-side and WTRU-side models are separately trained (e.g., at the NW-side and the WTRU-side) respectively by the NW vendor and WTRU vendor.

Two-sided ML models may be ML models having a first-side of the model and a second-side of the model that reside in (e.g., or that are accessible at or available at) different nodes of a wireless network. Examples include, but are not limited to, the first-side model residing at the WTRU-side and the second-side model residing at the NW-side. For example, a two-sided ML model may include a first-side model (e.g., WTRU-side model) associated with a first node (e.g., the WTRU) and a second-side model (e.g., NW-side model) associated with a second node (e.g., NW, peer/sidelink WTRU, etc.) in the wireless network. The WTRU may be configured to determine the error cause by determining an identity of a device (e.g., the first node, the second node, etc.) at which the error cause occurred when implementing the ML model. In an example, a two-sided ML model may be an AE model, which may be used for AI/ML-based CSI compression. In this example, the first-side model may refer to a WTRU-side ML encoder, and the second-side model may refer to a NW-side ML decoder.

In an example, a first type of the first-side model may be known at the NW (e.g., reference WTRU-side ML encoder model) and a second type of the first-side model may be unknown at the NW (e.g., an enhanced/optimized WTRU-side ML encoder model).

Throughout the present disclosure, a WTRU-side ML encoder of a two-sided model (e.g., AE) for CSI compression may be interchangeably referred to herein as a CSI generation part, a WTRU-side ML encoder, ML encoder part, CSI generation part, and/or first-side model. Furthermore, a NW-side ML decoder of the two-sided AE model for CSI compression may be interchangeably referred to herein as a CSI reconstruction part, NW-side ML decoder, ML decoder part, CSI reconstruction part, and/or second-side model.

Example WTRU configurations for error cause determination (e.g., for two-sided models independently trained) are described herein. A WTRU may be configured to receive a configuration to enable WTRU-based error cause determination. The terms WTRU-based error cause determination and error cause determination may be used interchangeably herein.

Example configurations of a NW-side AI/ML model at the WTRU (e.g., for model pairing) are described herein. A WTRU may be configured to receive an indication of one or more WTRU-side AI/ML model(s) (e.g., encoder models) for which to determine an error cause, for example, when the WTRU-side model(s) and/or model IDs are known at the NW-side. A WTRU-side AI/ML model may be associated with one or more NW-side AI/ML models (e.g., decoder models). A WTRU may receive a configuration for one or more NW-side AI/ML models.

The configuration may include an identification number (e.g., or other ID). For example, a WTRU may receive a vendor ID associated with the NW-side AI/ML model. For example, the WTRU may receive a model ID associated with the NW-side AI/ML model. The WTRU may receive a dataset ID (e.g., ID of the first dataset, etc.) associated with the NW-side AI/ML model and/or training of the WTRU-side reference AI/ML model. The WTRU may receive an ID associated with one or more parameters of a reference NW-side AI/ML model. The WTRU may receive an ID associated with one or more parameters of a reference WTRU-side AI/ML model (e.g., encoder model), which may include one or more parameters used to train the NW-side AI/ML model.

The configuration may include parameters of a model such as, for example, one or more parameters associated with a NW-side AI/ML model (e.g., reference NW-side model). For example, the parameters may include one or more parameters associated with a WTRU-side AI/ML model (e.g., reference WTRU-side model). Example parameters of a model may include (e.g., or indicate) a structure of the model, complexity of the model, weights of the model, model type, and/or hyper-parameters.

The configuration may include a dataset used to train a model (e.g., the first dataset, etc.). For example, the WTRU may receive the dataset used to train a NW-side AI/ML model and/or the reference WTRU-side model. For example, the WTRU may receive statistical information of a dataset used to train a NW-side AI/ML model.

The WTRU may be configured to use the configuration of the one or more NW-side AI/ML model (e.g., decoder) to select an associated or matching WTRU-side AI/ML model (e.g., encoder). The WTRU may use the configuration of the one or more NW-side AI/ML model (e.g., decoder) to determine or select a proxy decoder AI/ML model. The WTRU may be configured to use the proxy AI/ML decoder model to train a WTRU-side AI/ML model.

Example configurations for error cause assessment measurements are described herein. A WTRU may receive an indication (e.g., a request) to perform error cause assessment measurements. The error cause assessment measurements may be configurable. For example, the WTRU may receive a configuration for the error cause assessment measurements.

The configuration may include an indication of an OOD detection method. For example, the WTRU may be configured with a method to detect if channel measurement samples (e.g., measured on Reference Signal) are out-of-distribution or in-distribution with respect to a dataset (e.g., first dataset, reference dataset).

The configuration may include an indication of parameters for OOD detection. For example, the WTRU may be configured with a threshold value for the number of measurements and/or measurement samples required to perform OOD detection. For example, the WTRU may be configured with statistical information of a first dataset (e.g., reference dataset) on which to determine in-, or out-of-distribution. In an example, the dataset may be indicated as the dataset used to train (e.g., at the NW) a reference WTRU-side AI/ML model.

The configuration may include an indication of an intermediate performance indicator (e.g., KPI) to measure. For example, the WTRU may be configured to measure Generalized Cosine Similarity (GCS), SGCS, Mean Square Error (MSE), Minimum MSE (MMSE), and/or Normalized MSE (NMSE).

The configuration may include an indication of intermediate performance indicator (e.g., KPI) input values. For example, the WTRU may be configured with values on which to determine the intermediate KPI (e.g., pairs of values used to compute a KPI measurement). Such values may include measurements performed on one or more reference signals (RS), quantized measurements performed on one or more RS, RI (e.g., determined from measurements performed on the one or more RS), CQI (e.g., determined from measurements performed on the one or more RS), precoding matrix indicator (PMI) (e.g., determined from measurements performed on the one or more RS), Eigenvectors/Eigenvalues (e.g., determined from measurements performed on the one or more RS), Channel matrix (e.g., determined from measurements performed on the one or more RS), interference (e.g., determined from measurements performed on the one or more RS), input of a WTRU-side AI/ML model, output of a WTRU-side AI/ML model, input of a proxy NW-side AI/ML model (e.g., proxy decoder), and/or output of a proxy NW-side AI/ML model (e.g., proxy decoder).

The configuration may include an indication of Intermediate performance indicator (e.g., KPI) threshold(s). For example, a WTRU may be configured with an intermediate KPI threshold. When an intermediate KPI goes below or exceeds the intermediate KPI threshold, the WTRU may be configured to determine to fallback to non-AI/ML operation, to switch WTRU-side AI/ML model, and/or to send an indication to the NW, for example.

The configuration may include an indication of a time period threshold or counter. The WTRU may receive an indication or determine a start of an assessment time period. The WTRU may determine a time period threshold as a function of the time of the start of an assessment time period. For example, the WTRU may be configured to adapt and/or perform error cause assessment measurements and/or reporting, based on the time period threshold. In another example, the WTRU may start a counter when it receives an indication or determines a start of an assessment time period. The WTRU may adapt and/or perform error cause assessment measurement and/or reporting based on the counter value or based on whether the counter value is above or below a threshold value.

The configuration may include an indication of counters and/or timers. For example, a WTRU may be configured with a counter and/or a timer. The WTRU may determine and/or update a counter or a timer based on error cause assessment measurements. For example, a WTRU may determine or assess an error cause when a counter or timer is below or exceeds a threshold for at least one error cause assessment measurement.

Example configurations for performing error cause assessments (e.g., determinations) are described herein. A WTRU may be configured with triggers to perform an error cause assessment. Performing the error cause assessment may include performing error cause assessment measurements (e.g., collecting measurements for an assessment mode associated with a ML model), assessing (e.g., determining) one or more error causes, reporting one or more error cause assessment measurements, and/or reporting an assessed (e.g., determined) error cause.

The triggers to perform error cause assessment may include receipt of an indication from the NW. In an example, the indication may indicate to the WTRU to start or stop error cause assessment. In an example, the indication may indicate to the WTRU a degradation of E2E performance. In an example, the indication may indicate to the WTRU the E2E performance.

The triggers may include E2E performance compared to a threshold. For example, the WTRU may be configured with a threshold for E2E performance and may be triggered to perform error cause assessment based on the E2E being above or below the configured threshold.

The triggers may include WTRU determination of E2E performance. For example, a WTRU may determine E2E performance as a function of HARQ-NACK rate, BLER, average latency, throughput, MCS, Scheduled MCS compared to reported CSI, QoS requirements, and/or number of (e.g., average number of) retransmissions.

The triggers may include time. For example, a WTRU may preform error cause assessments periodically at times determined based on a period and/or offset. For example, the WTRU may perform error cause assessment as a function of time since a previous performance of error cause assessment, an activation/deactivation of a WTRU-side or NW-side AI/ML model, and/or a lifecycle management (LCM) function (e.g., model switch, model training, model update) associated with an AI/ML model.

The triggers may include a trigger based on a WTRU-side AI/ML. For example, the WTRU may be triggered to perform error cause assessment based on a change of capability or applicability of a WTRU-side or NW-side AI/ML model.

The error cause assessment configuration may also include error cause types. For example, the WTRU may determine or detect or report data drift with respect to a reference dataset (e.g., first dataset), data drift with respect to an enhanced dataset (e.g., where the enhanced dataset may be a superset of a reference dataset), a first-side model error which may indicate a first type of first-side model error (e.g., WTRU-side reference AI/ML model error/failure) or a second type of first-side model error (e.g., WTRU-side enhanced AI/ML model error/failure), an unknown/unidentified/undetermined error cause type, a WTRU-side proxy decoder model failure, a WTRU-determined second-side model error (e.g., NW-side AI/ML model error/failure), and/or a combined WTRU-side and NW-side AI/ML model (or model pairs) failure.

The error cause assessment configuration may also include an indication of resources to report an assessed (e.g., determined) error cause indication or an error cause assessment measurement.

The error cause assessment configuration may also include triggers to report an assessed error cause indication or an error cause assessment measurement. For example, the triggers may include received NW indication, WTRU assessment completion, time period (e.g., for periodic reporting), time offset from reception or determination of a trigger, error cause assessment measurement value (e.g., above or below a threshold), and/or LCM function associated with at least one of WTRU-side or NW-side AI/ML model. For example, the triggers may be the same as, or associated with, the triggers used for triggering error cause assessment performance described herein.

Example WTRU measurements for error cause determination are described herein. The WTRU may be configured to perform (e.g., or collect) measurements for error cause assessment, e.g., during the first error cause measurement window (e.g., first window, time window, etc.).

The measurements may include WTRU-side statistics for E2E performance (e.g. HARQ ACK/NACK statistics, BLER, RI, CQI). The WTRU may perform these measurements for the duration of the whole error cause measurement window or for a fraction of the length of the error cause measurement window. If the WTRU-measured E2E performance KPIs are below a minimum configured threshold, for example, the WTRU may be configured to autonomously fall back to non-AI/ML CSI feedback for a next CSI reporting occasion and/or to deactivate the ML encoder model. In one example, the WTRU may continue to perform measurements for the error cause assessment for the deactivated ML encoder model for the remainder of the measurement window. In another example, the WTRU may deactivate the error cause measurement mode, for example, when it deactivates the WTRU-side ML encoder model and/or falls back to non-AI/ML operation.

The measurements may include intermediate KPIs (e.g. SGCS, NMSE, MSE). The WTRU may be configured to determine the performance of its ML encoder with its proxy decoder using these KPIs.

The WTRU may be configured to, if the measurement window length exceeds a configured threshold for example, make or collect distribution measurements to determine whether current data is in-distribution or OOD with respect to the first (e.g., reference) dataset. The OOD measurement method may be a pre-trained AI/ML model (e.g. OOD classifier) or a function. The result may be an OOD score (e.g., a probability distribution of K clusters representing the distributions) or an OOD flag (e.g., a boolean value indicating whether or not the CSI sample is within distribution with respect to the first (reference) dataset or not). The WTRU may additionally or alternatively determine whether the current data is in-distribution or OOD with respect to the second (e.g., enhanced) dataset. In an example, the WTRU may be configured to employ multiple ML encoders trained on multiple device specific datasets, e.g., {U1_1, U1_2, . . . , U1_K}, where each dataset corresponds to different environment conditions (e.g. WTRU speed, scenarios, channel conditions). In this example, the WTRU may be configured to calculate the OOD measurement with respect to all of the device specific datasets and/or with respect to one or more of the device specific data sets.

Example WTRU procedures for error cause determination and mitigation are described herein. Within examples, the terms error cause, error source, source of performance loss, source of error, and/or source of AI/ML model pairing may be interchangeably used herein to refer to an error cause. Furthermore, the terms AI/ML model and AI/ML functionality may be interchangeably used herein to refer to an AI/ML model.

In a solution, a WTRU may be configured to have one or more WTRU-side models corresponding to a NW-side model of a two-sided ML model. For example, a first type of WTRU-side model (e.g., of the one or more WTRU-side models) may be known at (e.g., or accessible at or available at) the NW (e.g., reference WTRU-side model). Furthermore, a second type of WTRU-side model (e.g., of the one or more WTRU-side models) may be unknown (e.g., or unavailable, etc.) at the NW (e.g., optimized WTRU-side model). The first type of WTRU-side model may be referred to herein as a common WTRU-side model, reference WTRU-side model, known WTRU-side model, standardized WTRU-side model, and/or a transferred WTRU-side model. The second type of WTRU-side model may be referred to herein as WTRU-specific WTRU-side model, enhanced WTRU-side model, optimized WTRU-side model, WTRU-dedicated WTRU-side model, and/or or unknown WTRU-side model.

For example, when a WTRU performs error cause estimation or determination, the WTRU may be configured to perform estimation or determination for the currently active WTRU-side model (e.g., first type of WTRU-side model or second type of WTRU-side model). Alternatively or additionally, to identify the error cause, the WTRU may be configured to perform estimation and/or measurement of one or more parameters, data distributions, and/or intermediate KPIs for both types of WTRU-side model (e.g., reference WTRU-side model and optimized WTRU-side model).

In another solution, a NW may have one or more NW-side models corresponding to a WTRU-side model of the two-sided ML model. A first type of NW-side model may be known at the WTRU (e.g., reference NW-side model) and a second type of NW-side model may be unknown at the WTRU (e.g., optimized WTRU-side model, or different from the reference NW-side model). Hereafter, the first type of NW-side model may be interchangeably referred to herein as a reference NW-side model, a known NW-side model, a standardized NW-side model, and/or a transferred NW-side model. The second type of NW-side model may be interchangeably referred to as an enhanced NW-side model, an optimized NW-side model, and/or an unknown NW-side model.

For example, when a NW performs error cause estimation or determination, the NW may be configured to perform estimation or determination for the currently active NW-side model (e.g., first type of NW-sided model or second type of NW-sided model). Alternatively or additionally, to identify an error cause, the NW may perform estimation and/or measurement of one or more parameters, data distributions, and/or intermediate KPIs for both types of the NW-side model (e.g., reference NW-side model and optimized NW-side model).

Example error cause types are described herein. In various examples, one or more error cause types may be used or defined. For example, a set of applicable error cause types may be different based on AI/ML use case, AI/ML configuration, NW-specific conditions, WTRU-specific conditions, and/or other conditions. Thus, when a WTRU determines an error cause for an AI/ML model, the WTRU may determine the error cause from one or more possible error cause types.

The error cause types may include data drift. For example, the WTRU may measure, estimate, and/or evaluate distribution of data (e.g., inference data, output data from the AI/ML model, etc.) and determine whether the distribution of data is OOD or in-distribution (InD). The reference used to determine whether the data (e.g., inference data) is OOD or InD may be data used for training and/or testing of the AI/ML model (e.g., the first dataset or the second dataset). The AI/ML model may be the WTRU-side model or the NW-side model, or both (e.g., when a two-sided model is used). The data to be evaluated, estimated, or measured to check whether it is OOD or InD may be a subset of data used for inference for the AI/ML model. One or more data drift types may be used to indicate which part of the data has a drift. For example, a first type of data drift may be associated with NW-side additional condition change (e.g., beam pattern, number of antennas, power level, number of TRP, etc.). A second type of data drift may be associated with WTRU-side additional condition change (e.g., WTRU speed, WTRU orientation, remaining battery level, signal-to-interference-plus-noise ratio (SINR) range, etc.). A third type of data drift may be associated with a condition change that is not part of a NW-side additional condition or WTRU-side additional condition (e.g., data drift occurred but a reason for the data drift was not identified). In an example, the WTRU may be configured to report data drift type when the WTRU determines that the error cause is data drift. The WTRU may be configured to use one or more parameters to determine data drift, such as mean value and/or variance of data distribution (e.g., statistical distribution, normal distribution), statistical distribution type (e.g., uniform, normal, Poisson, exponential distributions), one or more NW-side additional conditions (e.g., beam pattern, number of antennas, power level, number of transmission reception points (TRP), neighboring cell configuration, etc.), and/or one or more WTRU-side additional conditions (e.g., WTRU-speed, WTRU reception (Rx) antenna configuration, SINR range, WTRU remaining battery level, WTRU overheating level, etc.). Thus, the term data drift may be interchangeably used herein with the terms AI/ML model training condition change, dataset inconsistence between training and inference, NW-sided additional condition mismatch, and/or WTRU-side additional condition mismatch.

The error cause types may include a first-side model error (e.g., WTRU-side model of a two-sided ML model). When the two-sided model is used, for example, a WTRU may test the first-side model (e.g., WTRU-side model) and a NW may test the second-side model (e.g., NW-side model). For example, the WTRU may be configured to determine a first-side model error (e.g., WTRU-side model error or fault) when the first-side model is not performing properly. Thus, for example, the WTRU may be configured to determine the error cause by associating an error (e.g., fault, performance degradation, decoding failure, etc.) with the first-side model.

The error cause types may include a second-side model error (e.g., NW-side model of the two-sided ML model). When two-sided model is used, for example, a WTRU may test the first-side model (e.g., WTRU-side model) and a NW may test the second-side model (e.g., NW-side model). For example, the NW (e.g., or the WTRU) may be configured to determine a second-side model error (e.g., NW-side model error) when the second-side model is not performing properly.

The error cause types may include both models (e.g., the first-side model and the second-side model).

The error cause types may include an unidentified error cause type. For example, when a WTRU fails to identify a specific error cause (e.g., data drift, one or more of the AI/ML models), the WTRU may be configured to determine or indicate this type of error cause. In some examples, the terms unidentified, undetermined, and/or unknown may be interchangeably used herein to refer to this type of error cause.

Examples are described herein for the determination of error cause types. In an example, a WTRU may be configured to determine one or more error cause type when the WTRU is requested, indicated, or triggered to perform measurement, estimation, and/or evaluation of an error cause associated with a currently active AI/ML model. The WTRU may determine one or more error cause types based on one or more criteria.

The WTRU may be configured to determine the error cause type based on E2E performance, such as number of negative HARQ-ACK (e.g., consecutive) in a recent transmission, number of negative HARQ-ACK for a downlink (DL) transmission with modulation and coding scheme (MCS) scheduled with reported CQI, gap between measured channel quality and scheduled MCS for a downlink transmission being higher than a threshold, and/or receipt of a performance indicator that indicates whether a current E2E performance is within an expected range or out-of-range. The performance indicator may be explicitly indicated (e.g., via Layer 1 (L1) signaling, Layer 2 (L2) signaling, or higher layer signaling). Alternatively or additionally, the performance indicator may be implicitly indicated (e.g., receipt of request for error cause determination, intermediate KPI reporting, request for AI/ML model performance monitoring outcome, etc.).

The WTRU may be configured to determine the error cause type based on intermediate KPI (e.g., SGCS, NMSE) performance. In an example, the WTRU may have both the first-side and second-side models and may evaluate intermediate KPI at the WTRU-side. The second-side model available or used at the WTRU may be a proxy model. The proxy model may be developed at the WTRU based on the first-side model and/or based on a dataset applicable for the first-side model, the second-side model, or both models. The proxy model may be compatible with the first-side model and may be different from the second-side model used at a gNB (e.g., or other NW node). The proxy model may be transferred from the gNB or a third party server to the WTRU. In an example, a NW may have both the first-side model and the second-side model. In this example, the NW may be configured to evaluate intermediate KPI and inform the WTRU. In this example, the WTRU may be configured to report or provide ground-truth data to the NW to evaluate the intermediate KPI.

Additionally or alternatively, the WTRU may be configured to determine the error cause type based on one or more of data distribution of a WTRU-side model, data distribution of a NW-side model, NW-side conditions (and/or NW-side additional conditions), and/or WTRU-side conditions (and/or WTRU-side additional conditions).

The WTRU may be configured to determine one or more error cause types, such as data drift, first-side model errors, second-side model errors, both side model errors, and undefined error cause types, when one or more of their respective associated conditions are met.

The one or more conditions associated with data drift may include a gap between a data distribution parameter of inference and training being larger than a threshold. For example, the WTRU may be configured to determine that the error cause is data drift if a gap between mean value (and/or variance) of inference data distribution and mean value (and/or variance) of training data distribution is larger than a threshold value. The threshold value may be predefined, pre-configured, configured, and/or indicated to the WTRU by the NW.

The one or more conditions associated with data drift may include at least one NW-side additional condition being different between training and inference. The NW-side additional condition may include, but is not limited to, number of antenna elements, beam width, beam pattern, number of beams, number of active antenna panels, mode of operation (e.g., energy saving mode), physical cell-ID, cell-loading, and/or global cell-ID.

The one or more conditions associated with data drift include at least one WTRU-side additional condition being different between training and inference. The WTRU-side additional condition may include, but is not limited to, number of active antenna elements, receive antenna configuration (e.g., panel), WTRU-speed, SINR range, WTRU energy level, geographical location of the WTRU, WTRU orientation, WTRU rotation status, overheating status of the WTRU, and/or channel condition (e.g., indoor, outdoor, delay spread, Doppler spread, etc.).

The one or more conditions associated with first-side model (e.g., WTRU-side model) errors includes the data distribution of the currently active WTRU-side model being InD) and E2E performance being below a threshold. For example, the WTRU may determine that the WTRU-side model is the error cause if intermediate KPI performance is below a threshold with currently active WTRU-side model, but intermediate KPI performance is higher than the threshold with any alternative WTRU-side model compatible with the NW-side model. As another example, the WTRU may determine that the currently active WTRU-side model is the error cause if the currently active model is an enhanced (e.g., optimized) WTRU-side model, data distribution of a reference WTRU-side model is InD, and data distribution of the currently active model is OOD. As another example, the WTRU may determine that the currently active WTRU-side model is the error cause if the currently active model is an enhanced (e.g., optimized) WTRU-side model that is OOD, and there is an alternative WTRU-side model which is compatible with currently active NW-side model and is InD. For instance, the WTRU may perform data distribution evaluation of one or more alternative WTRU-side model and if any one of the alternative WTRU-side model is InD, the WTRU may determine that the currently active WTRU-side model is the error cause.

As an example for conditions associated with a determination that the second side model (e.g., NW-side model) is the error cause, the NW may perform evaluation or estimation of error cause with assistance information from the WTRU including, for example, ground-truth data provided or reported from the WTRU, and/or a WTRU-side model provided, transferred, available, or delivered to the NW. As another example, the NW may determine that the second-side model (e.g., NW-side model) is the error cause, e.g., if intermediate KPI performance is below a threshold with currently active NW-side model but the intermediate KPI performance is above a threshold with any alternative NW-side model compatible with WTRU-side model. In this example, the NW may also indicate to the WTRU the determined error cause. As another example, the WTRU may determine that the second-side model is the error cause when one or more condition is met, such as data distribution of the currently active WTRU-side model is InD, E2E performance is below a threshold, and/or intermediate KPI performance with currently active WTRU-side model and with a proxy model for the second-side model is above a threshold.

As an example for conditions associated with a determination that the error cause is associated with both side models (e.g., WTRU-side model and NW-side model), the WTRU (or NW) may determine both first-side and second-side (e.g., WTRU-side and NW-side) models are the error cause when one or more conditions is met, such as data distribution of the currently active WTRU-side model is InD, E2E performance is below a threshold, and/or intermediate KPI performances with all possible combinations of first-side models and second-side models are below a threshold.

As an example for conditions associated with a determination that the error cause is undetermined, the WTRU may determine the error cause is undefined (e.g., unknown) when current measurement/estimation does not meet any of abovementioned error cause types (e.g., data drift, first-side (e.g., WTRU-side) model, second-side (e.g., NW-side) model, or both-sided model).

Example WTRU behaviors for mitigation based on error cause type are described herein. A WTRU may be requested, indicated, configured, and/or triggered to perform error cause determination and its associated mitigation behavior (e.g., mitigation action). The associated mitigation behavior may include but is not limited to reporting of the event, fallback, switch, activation, and/or deactivation of the currently active AI/ML model.

As an example WTRU mitigating behavior may include reporting the event (or event type). The WTRU may be configured to report the event and/or the estimate of the error cause in a periodic or aperiodic manner. The terms event and event type may be interchangeably used herein. One or more events may be (pre) configured to the WTRU or predefined. The WTRU may be configured to determine a reporting behavior (e.g., periodic, aperiodic, semi-persistent) based on the event. The WTRU may be configured to determine an event based on one or more of error cause type, NW-trigger, WTRU-autonomous detection, predefined conditions, and/or pre-configured conditions.

As an example for fallback to non-AI/ML functionalities, the WTRU may be configured to fallback to a scheme and/or procedure that is to be performed or used without necessarily having a life cycle management procedure defined or used for AI/ML functionalities, and/or a scheme/procedure defined by specification and/or known to both the WTRU and the NW.

As an example for fallback to a default setting of the AI/ML functionalities/models, the default setting may be a reference model/functionality used or configured. The reference model/functionality may be referred to herein interchangeably as a model/functionality known by both sides (e.g., WTRU and NW).

As an example for switching to another setting of the AI/ML functionalities/models, the NW may configure a setting of the AI/ML functionalities/models when a specific event has occurred. The event and its associated setting may be provided to the WTRU. Another example setting of the AI/ML functionalities/models may include an applicable model/functionality at the WTRU (or NW) that meets certain conditions (e.g., intermediate KPI and/or data distribution is in working condition or within configured or predefined conditions).

Furthermore, the mitigation behavior may include activation of a setting of the AI/ML functionalities/models, and/or deactivation of a setting of the AI/ML functionalities/models, in line with the discussion above.

The WTRU may be configured to determine different mitigation behaviors based on error cause type and/or an event type.

For example, if the WTRU determines the error cause as WTRU-side model and the WTRU has one or more WTRU-side models that meet a certain set of conditions (e.g., meet performance requirement), the WTRU may be configured to perform model switching to a candidate model from the list of available applicable models. In one solution, the WTRU may send a request to the NW for a second measurement window, for example, to evaluate the performance of the candidate WTRU-side model. The evaluation may include (e.g., or may be based on) WTRU-side E2E indicators and/or WTRU-side intermediate KPIs. The WTRU may receive a request for AI/ML model deactivation and fallback to non-AI/ML CSI, for example, if the E2E performance reassessed during the second measurement window does not meet a target.

As another example, if the WTRU determines that the error cause is associated with the WTRU-side model and there is no WTRU-side model meeting the certain set of conditions, the WTRU may fall back to a non-AI/ML functionality/model.

As another example, if the WTRU determines that the error cause is data drift, the WTRU may be configured to determine the mitigation action as fallback to non-AI/ML CSI feedback. In one solution, the WTRU may select to autonomously fall back to non-AI/ML operation, for example, if the WTRU determines that the current data is OOD with respect to the first (e.g., reference) dataset and the second (e.g., enhanced) dataset, and/or if the WTRU-measured E2E performance indicators are lower than a first configured E2E performance threshold. In one example, the WTRU may select to fall back to non-AI/ML operation during the first measurement window when (e.g., when additionally) the intermediate KPIs measured by the WTRU are below a second configured intermediate KPI threshold. In another solution, the WTRU may select and/or indicate the fall back to non-AI/ML operation as a recommended mitigation, for example, when the intermediate KPIs measured by the WTRU meet a second configured intermediate KPI threshold. In this case, the WTRU may include in the error cause report message, a request for model transfer or model parameter update for the WTRU-side ML proxy decoder to verify the performance of the WTRU-side CSI reconstruction model, for example. In an alternative solution, the WTRU may report to the NW the ground truth, e.g., to enable the NW to verify the WTRU-side intermediate KPI measurements.

The terms WTRU mitigation behavior, WTRU behavior, WTRU action, and WTRU mitigation action may be interchangeably used herein.

Examples for WTRU reporting of error cause measurements and error cause determinations are described herein. A WTRU may be configured to perform (e.g., collect) measurements to assess (e.g., determine) the error cause, and/or report one or more of the WTRU-assessed error cause, WTRU-selected measurements, and/or a mitigation action. The WTRU-selected measurements may be selected based on the WTRU-assessed error cause. The mitigation action may be WTRU-determined (e.g., autonomously) or WTRU-recommended.

Examples are described herein for measurement selection when the WTRU-assessed error cause is data drift. The WTRU may select one or more measurements to report, for example, when the WTRU-assessed error cause is data drift.

The one or more measurements may include a signal or flag indicating that the current data is out-of-distribution with respect to the first dataset (e.g., reference dataset, etc.).

The one or more measurements may include first and second order statistics of the current data, e.g., as determined during the first measurement window.

The one or more measurements may include one or more Z-scores calculated with respect to the clusters of the first dataset (e.g., reference), if configured. For example, the WTRU may receive assistance information related to the first dataset, the number of clusters, and/or mean and standard deviation of each cluster. In this example, the WTRU may determine to report the Z-score (or the Z-score averaged over each instance of the first measurement window) relative to each cluster of the first dataset. In another example, the WTRU may determine cluster information for the first dataset, such as the number of clusters, and the mean and standard deviation of each cluster. In this example, the WTRU may determine to report one or both of the Z-scores (or average Z-scores), and/or the mean and standard deviation of each cluster.

The one or more measurements may include distribution metrics of the current data (e.g., CSI data) relative to the first (e.g., NW indicated) dataset. The data distribution metrics may include the number of OOD detections or the rate of OOD detections relative to the first dataset (e.g., during the first measurement window); energy score measurement parameters (e.g., temperature parameter); a threshold for the energy score (e.g., used for OOD determination); a measured energy score relative to the first dataset; and/or channel conditions such as Doppler, delay spread, angular spread, TDCP, SNR, etc.

In one solution, the WTRU may be configured to report distribution metrics relative to the second (e.g., enhanced/WTRU-specific dataset). The distribution metrics may include a signal or flag indicating whether the current data is in-distribution or out-of-distribution with respect to the second dataset, number of OOD detections, and/or rate of OOD detections relative to the second dataset.

Examples are described herein for measurement selection when the WTRU-assessed error cause is a ML encoder fault. The WTRU may select one or more measurements to report, for example, when the WTRU-assessed error cause is a ML encoder fault. The one or more measurements may include a signal or flag indicating that the current data is in-distribution with respect to the first dataset, a signal or flag indicating that the measured intermediate KPIs do not meet configured thresholds, and/or measured intermediate KPIs. The measured intermediate KPIs may include loss function values, average SGCS, and/or average NMSE. The SGCS and NMSE may be averaged over the first measurement window. The SGCS may be reported for each layer or averaged over a number of layers.

Examples are described herein for measurement selection when the WTRU-assessed error cause is undetermined. When the WTRU-assessed error cause is undetermined, the WTRU selects to report one or more metrics. The one or more metrics may include measured intermediate KPIs, such as average SGCS, average NMSE, or loss function; WTRU-measured E2E performance indicators, e.g., HARQ ACK/NACK statistics, measured average BLER, average RI, average CQI; a signal or flag indicating the in-distribution or out-of-distribution status of the current data with respect to the first dataset; first and second order statistics of the current data; Z-scores calculated with respect to the clusters of the first dataset; and/or ground truth.

The WTRU may report the ground truth, for example, to enable the NW to determine the error cause. The ground truth may be the target CSI (e.g., raw CSI matrix, eigenvectors of the CSI matrix).

If one or more of the WTRU-measured E2E performance indicators are below a configured threshold, the WTRU may be configured to autonomously fall back to non-AI/ML operation and deactivates the ML encoder. When the WTRU autonomously falls back to non-AI/ML operation, the WTRU may be configured to determine and/or report the E2E performance indicators averaged from the start of the first measurement window up to the fallback instance, for example, corresponding to the AI/ML based operation. The WTRU may also report the E2E performance indicators averaged from the fallback instance to the end of the first measurement window, for example, corresponding to the non-AI/ML operation. The WTRU may also report the intermediate KPIs corresponding to the deactivated model (e.g., ML encoder), for example, to enable the NW to determine the error cause.

Examples are described herein for reporting the mitigation action. The WTRU may include an indication of the mitigation action in the error cause report. The mitigation action may be WTRU-autonomous or WTRU-recommended.

The WTRU-autonomous mitigation may include fallback to non-AI/ML based operation. When the WTRU determines to fall back to non-AI/ML operation before the first measurement window expires (e.g., when the E2E performance is below a first configured threshold), for example, the WTRU may implicitly report the autonomous mitigation during the first available CSI feedback reporting occasion, e.g., by using a non-AI/ML CSI report. When the WTRU uses the full first measurement window to assess the error cause and determine the mitigation, for example, the WTRU may report the autonomous fallback mitigation explicitly (e.g., jointly with the WTRU-assessed error cause and/or the WTRU measurements).

The report of the WTRU-recommended mitigation may include an indication of the recommended mitigation. For example, the WTRU-recommended mitigation may be a recommendation that the WTRU-side ML encoder model be switched to a candidate model. The candidate model may be the reference ML encoder model or a second (e.g., alternate) enhanced ML encoder model if available, for example.

The report of the WTRU-recommended mitigation may include a request for a (e.g., second) measurement window. For example, the WTRU may perform measurements (e.g., intermediate KPI, E2E metrics) to determine the performance of the candidate model (e.g., during the second window).

Examples reporting mechanisms are described herein. Upon performing measurements to assess the error cause, the WTRU may be configured to report one or more of: the WTRU-assessed error cause, the WTRU-selected measurements, and/or the mitigation action. The reporting may be done via radio resource control (RRC) signaling (e.g., using RRC measurement reports) or using Layer-1 reporting. In one example, the report may include a message size for reporting the WTRU-selected measurements (e.g., for the WTRU to request an uplink grant to accommodate the measurements message size). In one example, when the WTRU reports a WTRU-recommended mitigation, the report may include a recommendation type (e.g., a switch to the reference ML encoder model, a switch to a second enhanced ML encoder, or fall back to non-AI/ML operation). In some examples, the reporting may be aperiodic (e.g., triggered by a NW request for error cause assessment).

1. A Wireless Transmit/Receive Unit (WTRU) comprising:
a processor configured to:
receive configuration information for a machine learning (ML) model;
receive a request for activating an assessment mode associated with the ML model;
collect measurements for the assessment mode;
determine an error cause associated with the ML model based on the measurements, wherein the determined error cause includes an indication of at least one of: data distribution measurements being out-of-distribution (OOD) with respect to a dataset used to train the ML model, or an identity of a device at which the error cause occurred when implementing the ML model; and
send one or more reports that include at least one of: an indication of the error cause, an indication of a measurement related to the error cause, or an indication of a mitigation action for the error cause.

2. The WTRU of claim 1, wherein the request includes an indication of a time window, and wherein the processor is configured to collect the measurements during the time window indicated in the request.

3. The WTRU of claim 1, wherein the ML model is a two-sided ML model that includes a first-side model associated with a first node and a second-side model associated with a second node.

4. The WTRU of claim 3, wherein the first node is the WTRU.

5. The WTRU of claim 3, wherein the processor, to determine the error cause, is configured to associate an error with at least one of: the first-side model, the second-side model, or interoperability between the first-side model and the second-side model.

6. The WTRU of claim 3, wherein the processor, to determine the error cause, is configured to:
determine whether data associated with the collected measurements is out-of-distribution (OOD) with respect to training data used to train the first-side model or the second-side model; and
determine that the error cause corresponds to data drift based on a determination that the data associated with the collected measurements is OOD.

7. The WTRU of claim 1, wherein the configuration information includes one or more parameters for the assessment mode, wherein the one or more parameters include at least one of: an identifier associated with a dataset used to train a reference ML encoder, an identifier associated with parameters of the reference ML encoder, parameters for out-of-distribution (OOD) detection, or one or more threshold values associated with one or more intermediate key performance indicators (KPIs).

8. The WTRU of claim 1, wherein the processor, to collect the measurements, is configured to:
determine end-to-end (E2E) performance statistics associated with one or more of: hybrid automatic repeat request (HARQ) acknowledgement or negative acknowledgement (ACK/NACK), block error rate (BLER), rank indicator (RI), or channel quality indicator (CQI).

9. The WTRU of claim 1, wherein the processor, to collect the measurements, is configured to:
determine one or more intermediate key performance indicators (KPIs), wherein the one or more KPIs include at least one of square generalized cosine similarity (SGCS) or normalized mean square error (NMSE).

10. The WTRU of claim 1, wherein the request includes an indication of a time window, and wherein the processor, to collect the measurements, is configured to:
based on a length of the time window exceeding a threshold, determine whether the data distribution measurements are out-of-distribution (OOD) with respect to the dataset used to train the ML model.

11. The WTRU of claim 1, wherein the processor is configured to:
in response to a determination that the error cause corresponds to data drift, send, in the one or more reports, one or more channel state information (CSI) data distribution metrics relative to the dataset used to train the ML model.

12. The WTRU of claim 1, wherein the processor is configured to:
in response to a determination that the error cause is associated with a WTRU-side ML encoder, send, in the one or more reports, one or more intermediate key performance indicators (KPIs).

13. The WTRU of claim 1, wherein the processor is configured to:
in response to a failure to determine the error cause, send a report that includes an indication of one or more intermediate key performance indicators (KPIs) and one or more channel state information (CSI) data distribution metrics relative to the dataset used to train the ML model.

14. The WTRU of claim 1, wherein the mitigation action includes at least one of: a recommended mitigation action, or a determined mitigation action performed at the WTRU in response to the determination of the error cause.

15. A method performed by a Wireless Transmit/Receive Unit (WTRU), the method comprising:
receiving configuration information for a machine learning (ML) model;
receiving a request for activating an assessment mode associated with the ML model;
collecting measurements for the assessment mode;
determining an error cause associated with the ML model based on the measurements, wherein the determined error cause includes an indication of at least one of: data distribution measurements being out-of-distribution (OOD) with respect to a dataset used to train the ML model, or an identity of a device at which the error cause occurred when implementing the ML model; and
sending one or more reports that include at least one of: an indication of the error cause, an indication of a measurement related to the error cause, or an indication of a mitigation action for the error cause.

16. The method of claim 15, wherein the request includes an indication of a time window, and wherein collecting the measurements is during the time window indicated in the request.

17. The method of claim 15, wherein the ML model is a two-sided ML model that includes a first-side model associated with a first node and a second-side model associated with a second node.

18. The method of claim 17, wherein the first node is the WTRU.

19. The method of claim 17, wherein determining the error cause comprises associating an error with at least one of: the first-side model, the second-side model, or interoperability between the first-side model and the second-side model.

20. The method of claim 17, wherein determining the error cause comprises associating an error with data drift, and wherein associating the error with data drift comprises determining that data associated with the collected measurements is out-of-distribution (OOD) with respect to training data used to train the first-side model or the second-side model.
